(19) United States
(12) Patent Application Publication
(10) Pub. No.: US 2002/0114912 A1
(43) Pub. Date: Aug. 22, 2002

(54) Pseudo-rhinestone body art

(76) Inventor: Robert E. House, Laguna Beach, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/790,100

(22) Filed: Feb. 21, 2001

(51) Int. Cl. B32B 7/06

(52) U.S. Cl. 428/42.3

(57) ABSTRACT

The present invention relates to adhesive pseudo-rhinestone body art which can be produced inexpensively in a variety of shapes and patterns. A process for producing the pseudo-rhinestone body art is also disclosed. The pseudo-rhinestone body art is produced from a composite material which is die cut to form multi-sided jewels in an ornamental pattern. The ornamental pattern can be removed as a group by peeling the top layer off of the bottom, siliconized paper. The top layer with the ornamental pattern of jewels can then be applied to a surface, such as the skin, clothing or an object, and the jewels will stick more tightly to the desired surface then to the top layer. This allows a pattern of jewels to be applied as a group to a desired surface. The pseudo-rhinestone body art produced is attractive

### FIELD OF THE INVENTION

The present invention relates to adhesive pseudo-rhinestone body art. A process for producing the pseudo-rhinestone body art is also disclosed.

### BACKGROUND OF THE INVENTION

Although, it has been known in some countries for centuries, decorative body art is a growing trend world-wide and particularly in the United States and Europe. Jewels, mirrors, beads, glitter and other decorative items are regularly used in the clothing industry to produce ethnic and artistic designs. In addition, henna and tattoos are becoming a main-stream method of decorating the skin. Recently, the use of bindis, jewels which are placed in the middle of the forehead, has spread from India to mainstream America, becoming available at department stores as well as specialty stores.

A variety of body jewels, such as bindis, are available, including, single jewels which are removed from a non-stick backing and placed on the skin with an adhesive. A pattern can be produced with these jewels by separately peeling the jewels from the backing and producing the design manually on the surface of the skin. However, producing these patterns can be time-consuming, with more complicated designs taking a considerable amount of time and expense and, in some cases, requiring the help of a professional. An alternative to this is machine placement of the rhinestones. This is expensive because a machine has to be built and designed to produce the correct patterns. In addition, the types of rhinestones used tend to be expensive to make and would not allow for an inexpensive, disposable, single-use product.

Other types of body jewels are available in patterns and are attached to a thin plastic film with adhesive as a strip or sheet. This results in a sheet or strip of jewels with an adhesive or plastic background. Upon application, the strip or sheet with the jewels in a pattern is removed and applied to the skin or other surface. An example of such a method is that used for false eyelashes. The adhesive strip or sheet is meant to become invisible on the skin or surface it is applied to. However, it can be envisioned that as the patterns produced require more space between jewels, the possibility of the strip or sheet being visible as a background increases.

Therefore, the types and size of the patterns which can be produced is severely limited when using these types of body jewel. In addition, it is envisioned that complicated patterns are not likely to be reusable without having to reapply each jewel separately in the pattern. Therefore, it is preferable that the pattern be inexpensive, since it will likely only be used once. Up to this point, inexpensive, disposable, body art which can be applied in one step as a pattern without a background effect or without requiring the application of each jewel separately has not been available.

### SUMMARY OF THE INVENTION

The present invention solves the problem of applying a complicated pattern of jewels inexpensively and simply, by tailoring the stickiness of adhesives and using combinations of release materials in such a way that the pattern will remain attached to a transfer sheet when peeled from a foundation layer. When applied to skin or an alternative surface, the pattern will remain attached to the skin and the transfer sheet can be peeled off. This allows one to attach separate jewels as a pattern without applying each jewel separately or including a plastic or adhesive between the jewels. In addition, the present invention provides an inexpensive way to produce pseudo jewels using a plastic composite which is die cut in a variety of shapes and patterns. This type of jewel advantageously sticks better to the transfer sheet than the crystal jewels which tend to be heavier and more faceted.

One embodiment of the invention provides an adhesive ornament for application to skin, which has a foundation release layer and plural separate ornamental objects arranged in a decorative pattern on the foundation release layer. Each ornamental object has an adhesive layer attached to the release layer and a surface layer bonded to the adhesive layer. In addition, the adhesive ornament also has a transfer sheet, which overlies the foundation release layer and the separate ornamental objects. The transfer sheet is attached more strongly to the surface layer of the plural separate ornamental objects than the adhesive layer of the plural separate ornamental objects is attached to the foundation release layer, but it is attached less strongly to the surface layer of the plural separate ornamental objects than the adhesive layer of the plural separate ornamental objects bonds to skin. Preferably, the foundation layer has a silicone release liner. Preferably, the adhesive layer is a pressure-sensitive adhesive layer. The adhesive layer of the plural separate ornamental objects can be heavily doped with glitter, colored, silver or gold, or iridescent.

A further embodiment of the invention provides an applique for placing on a surface. The applique is an ornamental pattern of pseudo-rhinestones. The applique has a foundation sheet, a transfer sheet, and plural, separate pseudo-rhinestones sandwiched between the foundation sheet and the transfer sheet. The applique has a first adhesive attaching one surface of the pseudo-rhinestones to the foundation sheet, and a second adhesive attaching a second surface of the pseudo-rhinestones to the transfer sheet more strongly than the first adhesive attaches the one surface of the plural, separate pseudo-rhinestones to the foundation sheet, but less strongly than the first adhesive attaches, at room temperature, the one surface of the plural, separate pseudo-rhinestones to the surface.

An alternative embodiment of the invention provides an applique with plural pseudo-rhinestones arranged in a predetermined pattern, a foundation sheet supporting the plural pseudo-rhinestones, and a transfer sheet which lifts the plural pseudo-rhinestones from the foundation sheet and places the plural pseudo-rhinestones on human skin while maintaining the plural pseudo-rhinestones arranged in the predetermined pattern.

A further embodiment of the invention is a method of making an ornament for application to a surface, by first positioning a foundation layer in a face-to-face relationship with a second sheet, the second sheet having a pressure-sensitive adhesive layer doped with glitter and a clear plastic layer bonded to the adhesive layer. Next, the first and second sheets are placed in a press which has a die attached to one surface, the die has upraised ornament-forming elements arranged in a decorative pattern on the surface facing the sheets. The die is heated and pressed into the second sheet, and the temperature of the die is sufficient to melt through the second sheet to form upraised ornaments in patterns without severing the foundation layer. Adhesive is applied to a transfer sheet, the adhesive bonds more strongly to the clear plastic layer of the ornamental patterns than the adhesive layer bonds to the foundation layer. Lastly, the transfer sheet with the adhesive is placed over the pattern of ornaments and the foundation layer.

An alternative embodiment of the invention is a method for ornamenting human skin by positioning a pattern of pseudo-jewels on a foundation, positioning a transfer sheet over the pattern of pseudo jewels without removing the pattern of pseudo-jewels from the foundation, peeling the transfer sheet with the pattern of pseudo-jewels from the foundation, pressing the pattern of pseudo-jewels against human skin without removing the pattern of pseudo-jewels from the transfer sheet, and peeling the transfer sheet from the human skin without removing the pattern of pseudo-jewels from the skin.

### BRIEF DESCRIPTION OF THE DRAWINGS

FIG. 1 is an illustration of a typical die which can be used with the process of the preferred embodiment.

FIG. 2 illustrates the orientation of the various materials used in the process of the preferred embodiment within the press.

FIG. 3 is an enlarged view of one of the elements of the die of FIG. 1.

FIG. 4 is a cross section view showing the layers which comprise the composite and the foundation layer used in the preferred embodiment of the present invention.

FIG. 5 is a detailed cross section view illustrating the orientation of the various materials used in the process of the preferred embodiment of the present invention when the die is impressed upon them.

FIG. 6 is an exploded view of the materials used in the process of the preferred embodiment of the present invention after they are removed from the press.

FIG. 7 is a view of a pseudo-rhinestone pattern formed by the preferred embodiment.

FIG. 8 is a cross-section along lines 7-7 of FIG. 7.

FIGS. 9A and 9B illustrate the method of attachment of the pseudo-rhinestone pattern of the preferred embodiment to the skin.

### DETAILED DESCRIPTION OF THE PREFERRED EMBODIMENT

The present invention relates to both the process for making and using pseudo-rhinestone body art and to the pseudo-rhinestone body art itself. The pseudo-rhinestone body art is an attractive, inexpensive, decorative item which can be produced in a variety of patterns, colors and shapes. The pseudo-rhinestones can be produced from a material doped with glitter or pigments to replicate rhinestones. The patterns can be arranged in a variety of fashions. For example, a small group of jewels can make up a simple pattern such as a circle or a heart, while more elaborate patterns can be formed from a large group of jewels. Preferably, the individual jewels are octagonal or multifaceted. The pattern of jewels is sandwiched between a foundation layer and a transfer sheet. To apply the pseudo-rhinestone body art, the transfer sheet is peeled from the foundation layer, while the pattern remains attached to the transfer sheet. The transfer sheet and jeweled pattern is then applied to the skin. The transfer sheet is then peeled from the skin, leaving the pseudo-rhinestones in the original pattern on the desired surface.

The disposable pseudo-rhinestone body art of the present invention is particularly suitable for use as costume jewelry. For example a person may wear it upon various portions of the body, including the face, neck, chest, arm, and fingernails. Alternatively, the person may wear them upon articles of clothing, jewelry, or items such as books, telephones, notebooks, purses, and makeup cases.

A process for manufacturing the pseudo-rhinestone body art is disclosed that is simple and efficient. A layered composite sheet with a pressure sensitive adhesive layer and a clear plastic layer with glitter or some other decorative substance included, is placed closest to a die. A treated foundation layer is placed furthest from the die. The die cuts a pattern of jewels from the layered composite. After die cutting, the composite sheet surrounding the individual jewels may be peeled from the foundation layer leaving the jewels on the foundation layer. Because of the combined thickness of the composite, the heated die creates a curved surface on the top of the jewels if the jewels are cut small enough. The jewels are cut such that a group of them forms an ornamental pattern. The pattern can be from one inch to several inches in size. Once the pattern has been cut and the background or salvage material of the composite sheet is peeled away, the desired ornamental pattern remains attached to the foundation layer. The background or salvage is then discarded. Over the pattern of pseudo-rhinestones a final clear plastic transfer sheet is applied. This clear plastic transfer sheet is a thin sheet plastic with very weak pressure sensitive adhesive facing the jewel pattern. It is applied as a sheet to cover and protect the pseudo-rhinestones, and allow their application to a surface to be decorated as a group.

Alternatively, a standard layered composite with a clear plastic transfer sheet of heat-resistant material is placed closest to the die. An adhesive backs the composite on the surface closest the clear plastic transfer sheet. This assembly, along with a siliconized base layer is then placed into a press. When a heated die is impressed upon these materials, the heat applied to the die causes the die to cut the patterns on the die through the clear plastic transfer sheet. The die does not cut through the clear plastic transfer sheet because of the flexibility and high melting temperature of the clear plastic transfer sheet. However, the heat from the die causes the composite to be cut into a pattern of jewels on the die and to adhere to the clear plastic transfer sheet. The result is that the jeweled pattern composite adheres to the clear plastic transfer sheet. The clear plastic transfer sheet is then peeled away from the base layer. The jewels remain because the rest of the material is stripped away after they have been die cut. Then, the jewel pattern can be applied to a siliconized bottom sheet.

The pseudo-rhinestone body art and method of making and using the pseudo-rhinestone body art will now be described in further detail with reference to the drawings.

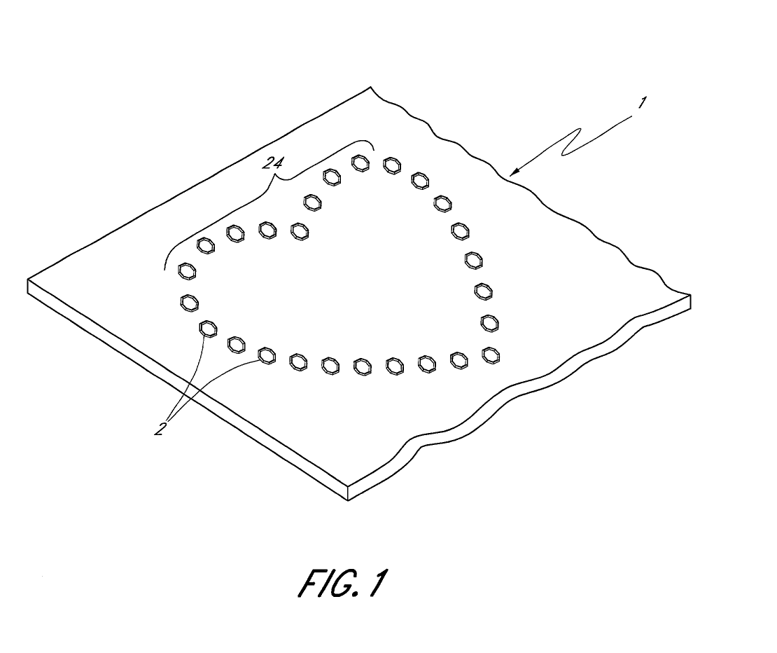

FIG. 1 shows a typical die 1 which can be used in the process of the preferred embodiment of the present invention. Plural, product-forming elements 2 of the die 1 are arranged into an ornamental pattern 24, such that they are spaced apart a distance sufficient to allow removal of the salvage material. Each product-forming element 2 will result in a separate jewel and the pattern of the jewels will result in an ornamental pattern 24. A variety of ornamental patterns 24 can be envisioned. In addition, the jewels produced by each product-forming element 2 can be shaped in a variety of geometric designs including a circle, star, heart, square, and triangle, but preferably the jewel is shaped in an octagonal or multisided geometric shape to replicate a rhinestone. For example, an ornamental pattern 24 can be produced in the shape of a heart using octagonal shaped product-forming elements 2 arranged in a heart shape.

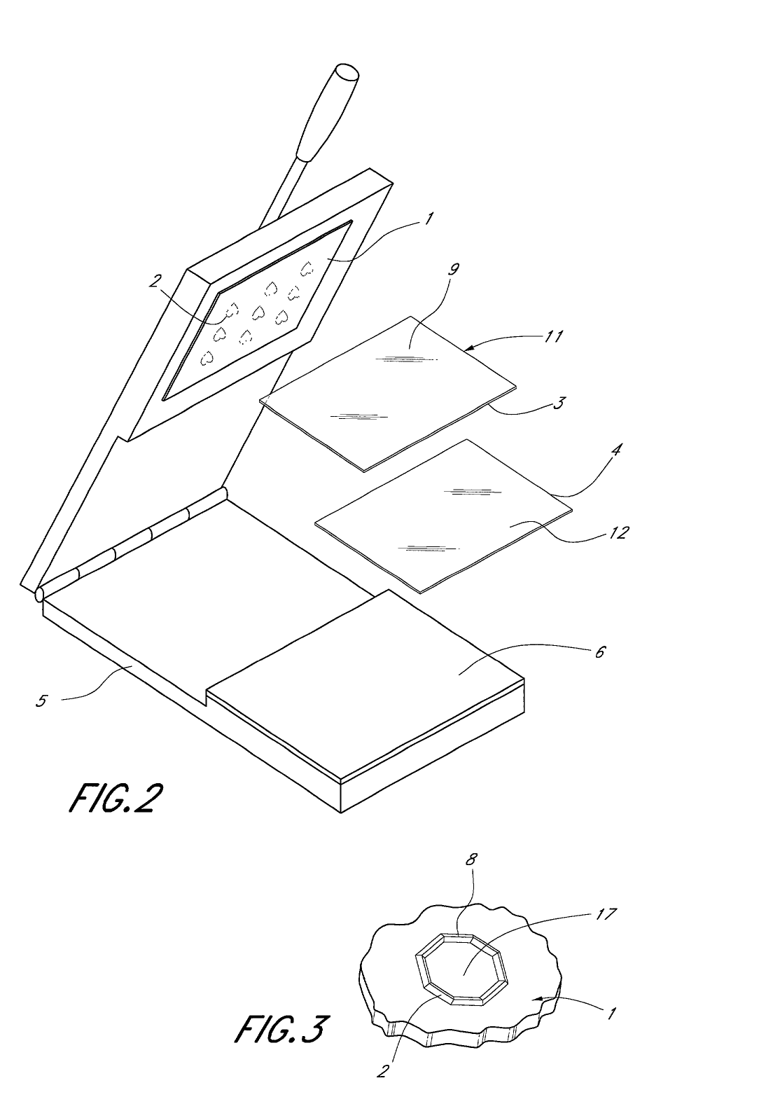

The die 1 is positioned in a press 5 as shown in FIG. 2. A composite material 11 composed of a pressure sensitive adhesive layer 3 and a clear plastic layer 9 is positioned in the press 5. The clear plastic layer 9 of the composite material 11 faces the die 1, while the pressure sensitive adhesive layer 3 faces a foundation release layer 4. A bottom pressure plate 6 is used to transfer forces from the die 1 to the press 5.

The means for heating the die 1 are not shown in this drawing, but, as is typical in operations of this type, the upper plate of the press 5 includes a heating element which raises the temperature of the die 1, typically to about 500° F. the product-forming elements 2 of the die 1, as shown in FIG. 3, include raised edges 8 which may be either pointed, as shown in FIG. 3, or somewhat flattened. In either case, however, the element 2, which may be of any desired shape, includes a recessed central area 17.

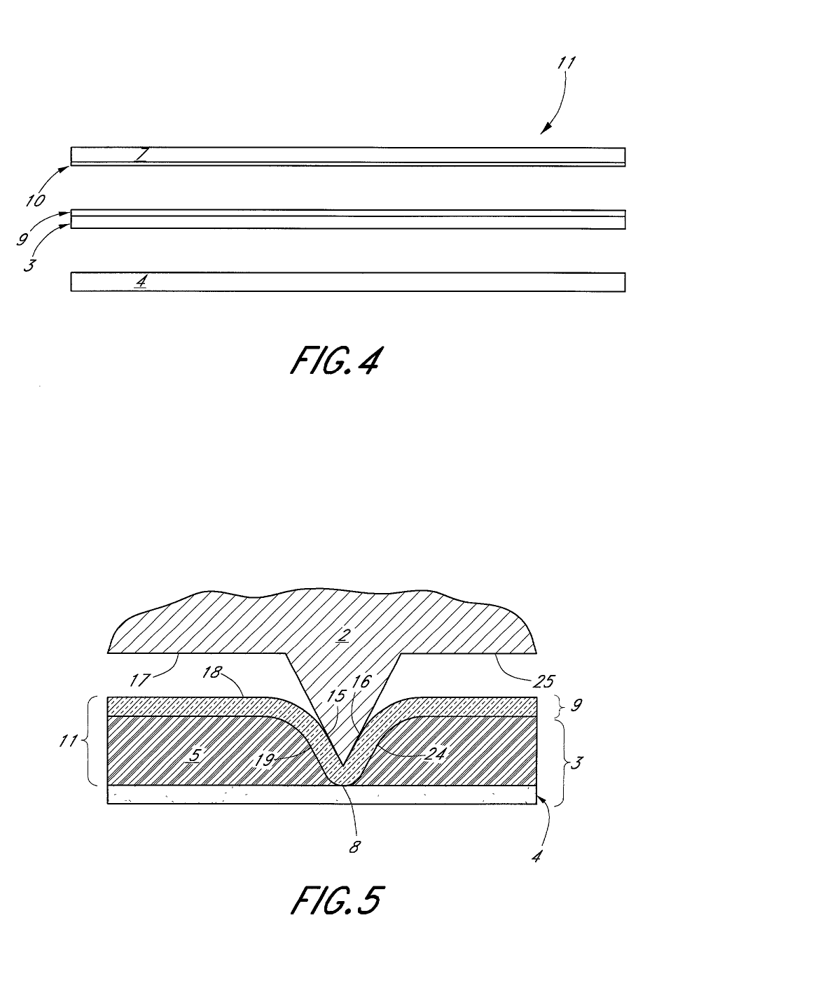

FIG. 4 illustrates the commercially available composite 11 and the layers which comprise the composite 11. The composite can be purchased with the foundation layer 4. The foundation layer 4 is typically formed as a silicone release liner. This layer may be as described, for example, in U.S. Pat. No. 4,533,566 herein incorporated by reference, or may be a paper layer with a silicone or equivalent coating. The coating is on the top of the foundation release layer 4 and is any substance which bonds poorly to pressure-sensitive (or heat sensitive) adhesives. The next layer of the composite 11 is a pressure sensitive adhesive layer 3 which is decorated with glitter, color or some type of decorative substance. Preferably, the adhesive is an acrylic monomer which is pressure sensitive. Alternatively it may be rubber-based. Preferably the adhesive is doped with glitter. Preferably, the pressure sensitive adhesive layer is from about 0.006 to about 0.008 inches thick. The thickness of the adhesive layer to skin should be about 0.006 to about 0.008 inches thick, and to paper should be about 0.015 inches including the thickness of the paper.

The next layer of the composite 11 is a clear plastic layer 9. Preferably, the clear plastic layer 9 is from about 0.003 to about 0.005 inches thick. More preferably, the clear plastic layer 9 is from about 0.003 to about 0.005 inches thick. Preferably the clear plastic is about 0.003 to about 0.005 inches thick. The pressure sensitive adhesive layer 3 and the clear plastic layer 9 are typically purchased together from any one of several manufacturers who mass produce plastic film as a composite 11. This film is similar to the base layer of U.S. Pat. No. 4,581,088 herein incorporated by reference. In this case, as an alternative to adding pigment to the plastic film, the film itself 9 may be clear, and the composite sheet may be given a decorative appearance by dispersing decorative material throughout the pressure sensitive adhesive 3. The decorative material may be a color, or a substance such as glitter.

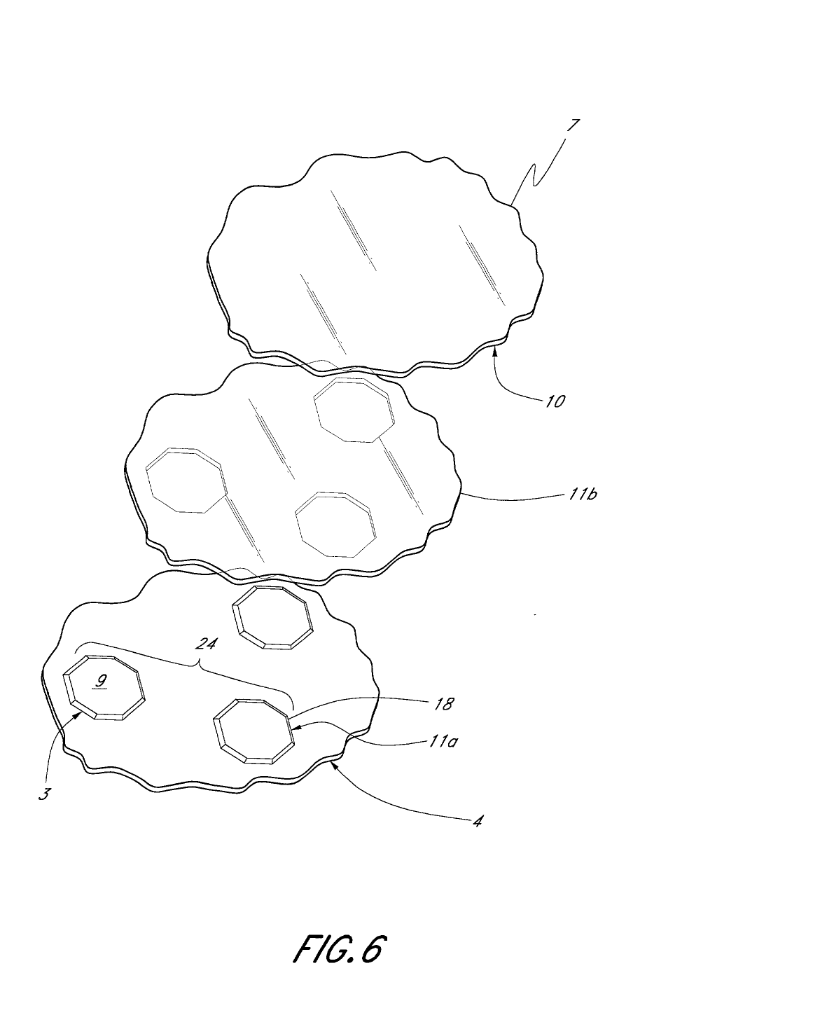

With continued reference to FIG. 4, the foundation layer 4, the pressure sensitive adhesive layer 3 and the clear plastic layer 9 may be sold by these manufacturers as a composite on a roll, with the silicone release foundation layer 4 protecting the pressure sensitive adhesive layer 3. Such composites can be die cut into letters or designs for decorative use. After die cutting, the composite 11 of the pressure sensitive adhesive layer 3 and the clear plastic layer 9 may be peeled from the foundation layer 4, and applied using the adhesive layer 3 to an article to be decorated (see patent U.S. Pat. No. 4,581,088 herein incorporated by reference). In this invention, however, small jewels 18 (see FIG. 6) are die cut in the clear plastic layer 9. As shown in FIG. 5, the jewels 18 are cut with a heated die 2, and, because of the combined thickness of the clear plastic layer 9 and the adhesive layer 3, the heated die 2 creates a curved surface on the top of the jewels 18 if the jewels 18 are small enough (preferably less than about 0.25 inches in their smallest dimension). The jewels 18 are cut such that a group of jewels form a pattern 24 which will be applied to the user's skin. The group may be from one inch in size to several inches. Once the group has been cut, the salvage material of the composite layer 11 is peeled back leaving the group or groups of formed jewels 18. The salvage or background material is then discarded.

FIG. 5 is an illustration of the process which is the subject of the present invention. The materials 9 and 3 are shown positioned adjacent to and in contact with each other. The materials 9 and 3, are positioned in the press 5 (see FIG. 2) along with the foundation layer 4, and the heated die I is shown impressed upon them so that the element 2 (see FIG. 3) compresses and heats the materials 9 and 3, allowing the raised edges 8 to sever the materials 9 and 3 as shown in FIG. 5.

With continued reference to FIG. 5, the material is assembled in the press 5 (the press is shown in FIG. 2) so that the pressure sensitive adhesive layer 3 and a clear plastic layer 9 is positioned with the clear plastic layer 9 of the composite material 11 facing the die, while the pressure sensitive adhesive layer 3 faces the foundation release layer 4. It is to be understood that a cushioning material, such as paper, may be inserted between the press 5 and the foundation release layer 4, if desired, to increase the area of the die elements 2 which contact the composite material 11.

With continued reference to FIG. 5, the force on the press 5 (the press 5 is shown in FIG. 2) is such that the raised edges 8 of the die element 2 do not cut the foundation release layer 4. The edge 8 of the element 2 does, however, melt through the composite 11 (the clear plastic layer 9 and the pressure sensitive adhesive layer 3). The heat applied to this layer will produce rounded edges on the jewels produced by the cutting.

Referring to FIG. 6, the manufacturing process is completed by first peeling the material 11 away from the foundation release layer 4. This removes the salvage or background material 11b and leaves the jewels 18 (or 11a) in the form of a pattern 24 still attached to the foundation release layer 4.

A clear transfer sheet 7 is then layered on top of the foundation release layer 4 containing the jeweled pattern 24. The clear transfer sheet 7 includes an adhesive 10 which sticks to the top of the jewels 18 and to the foundation release layer 10 between the jewels 18. The adhesive 10 binds more strongly to the jewels 18 than the adhesive layer 3 binds to the foundation layer 4. The pressure sensitive adhesive 3 binds more tightly to the object or skin which will receive the pseudo-rhinestone body art, than the adhesive 10 binds the clear plastic layer 9 to the transfer sheet 7.

Because of the differences in the adhesive qualities of adhesive 10 and the pressure sensitive adhesive layer 3, with reference to FIG. 6, when the transfer sheet 7 is peeled from the foundation release layer 4, the jewels 18 remain attached to the transfer sheet 7 in the original ornamental pattern 24. The jewels 18 and the transfer sheet 7 are then contacted with the skin or object to be decorated. The pressure sensitive adhesive layer 3 attaches the jewels 18 to the skin or object more tightly than the clear plastic layer 9 of the jewels 18 is attached to the adhesive 10 on the transfer sheet 7. Therefore, the jewels 18 remain bound to the skin (or other object to be decorated) and the transfer sheet 7 is removed. The jewels 18 are left in the original ornamental pattern 24 on the skin or object, producing pseudo-rhinestone body art.

One jewel of the product resulting from the process of the present invention is shown in FIG. 7. It is to be understood that the embodiment shown in FIG. 7 is for the purposes of illustration and does not serve as a limitation upon the shapes and patterns which may be assumed. FIG. 8 shows a cross section of the jewel in which it can be seen that the transfer sheet 7 does not fit tightly to all parts of the jewel 18, but only to the top.

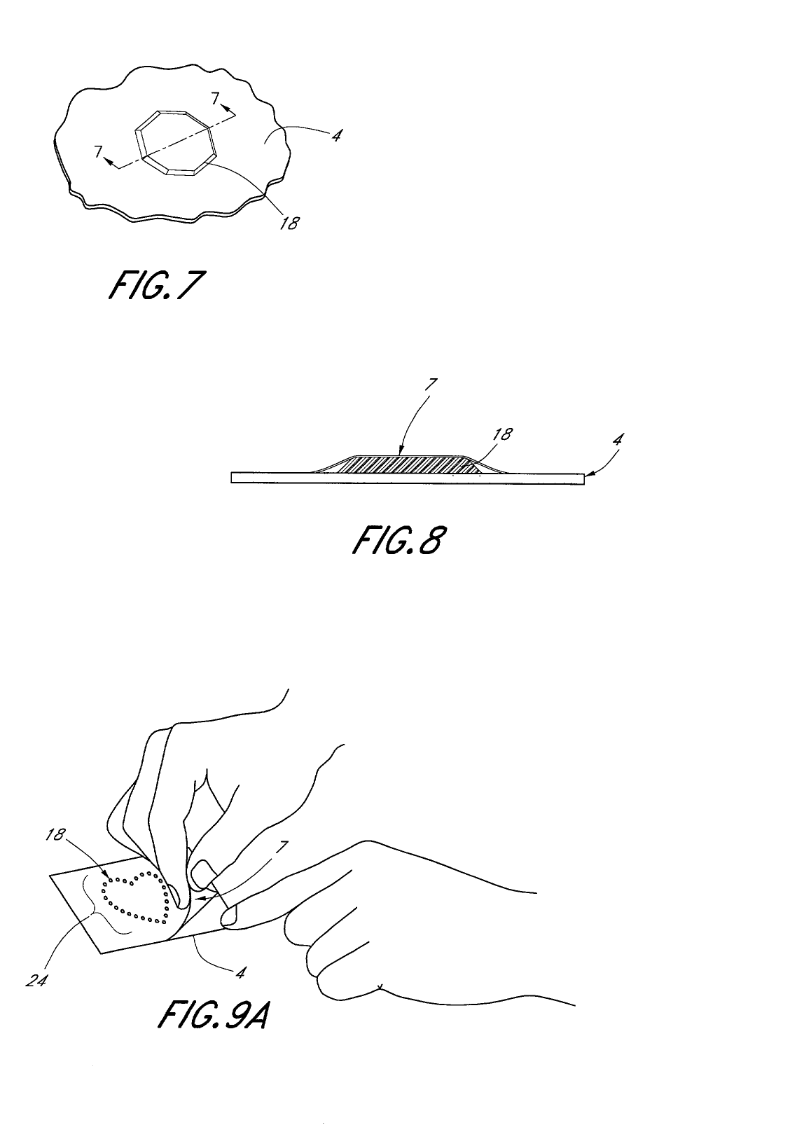

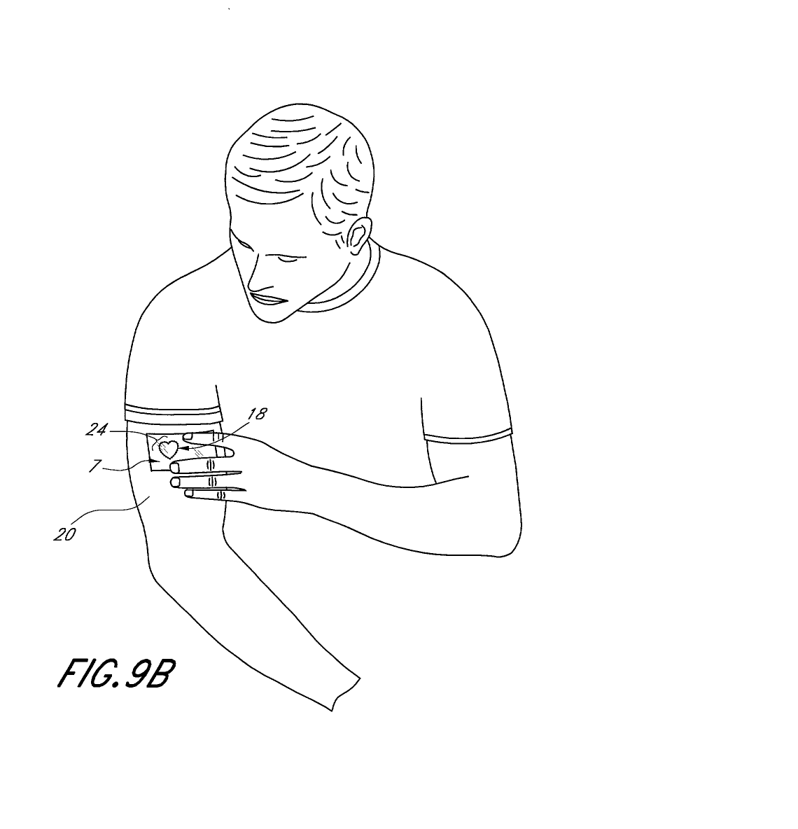

FIGS. 9A and 9B show how the product of the preferred embodiment is used. In FIG. 9A, initially, the transfer sheet 7 is peeled away from the foundation release layer 4 by the user of the product. The jewels 18 in the ornamental pattern 24 remain attached to the transfer sheet 7. With reference to FIG. 9B, the transfer sheet 7 with the attached jewels 18 is then applied to the surface 20. Because of the adhesive properties, the jewels 18 in the ornamental pattern 24 remain attached to the skin 20 and the transfer sheet 7 is peeled away, leaving the ornamental pattern 24 on the skin 20. Because the adhesive is attached separately to each jewel 18, there is no adhesive showing between the jewels 18 and the rhinestone pattern 24 is cleanly applied to the skin 20.

Because the jewels 18 of the present invention are so inexpensively made, the rhinestone pattern 24 can be discarded after use and a new pattern used subsequently. In addition, the material used to make the jewels of the present invention results in lighter jewels with a surface more amenable to sticking to the transfer sheet. Therefore, they are more likely to be held in place when the transfer sheet is removed in readiness for application. Crystal jewels are heavier and may often move out of position as the transfer sheet is removed from the foundation layer, altering the ornamental pattern. Therefore, the jewels of the present invention result in a cleaner and easier application.

What is claimed is:

1. An adhesive ornament for application to skin, comprising:
a foundation release layer;
plural separate ornamental objects arranged in a decorative pattern on said foundation release layer, each comprising:
a) an adhesive layer attached to said release layer; and
b) a surface layer bonded to said adhesive layer,
said adhesive ornament further comprising;
a transfer sheet, which overlies said foundation release layer and said separate ornamental objects, said transfer sheet being:
a) attached more strongly to said surface layer of said plural separate ornamental objects than said adhesive layer of said plural separate ornamental objects is attached to said foundation release layer, but
b) attached less strongly to said surface layer of said plural separate ornamental objects than said adhesive layer of said plural separate ornamental objects bonds to skin.

2. The adhesive ornament of claim 1 wherein said foundation layer comprises a silicone release liner.

3. The adhesive ornament of claim 1 wherein said adhesive layer of said plural separate ornamental objects comprises a pressure-sensitive adhesive layer.

4. The adhesive ornament of claim 3 wherein said pressure-sensitive adhesive layer of said plural separate ornamental objects comprises an acrylic monomer.

5. The adhesive ornament of claim 1 wherein said adhesive layer of said plural separate ornamental objects is thicker than said surface layer of said plural separate ornamental objects.

6. The adhesive ornament of claim 1 wherein said surface layer of said plural separate ornamental objects comprises a clear plastic layer.

7. The adhesive ornament of claim 1 wherein said adhesive layer of said plural separate ornamental objects is 0.006 to 0.008 inches thick.

8. The adhesive ornament of claim 1 wherein said surface layer of said plural separate ornamental objects is about 0.004 inches thick.

9. The adhesive ornament of claim 1 wherein said adhesive layer is opaque.

10. The adhesive ornament of claim 1 wherein said adhesive layer of said plural separate ornamental objects is heavily doped with glitter.

11. The adhesive ornament of claim 1 wherein said transfer sheet is transparent.

12. The adhesive ornament of claim 1 wherein said transfer sheet is a thin sheet of clear plastic.

13. The adhesive ornament of claim 1 wherein said plural separate ornamental objects are colored.

14. The adhesive ornament of claim 13 wherein at least one of said plural separate ornamental objects is colored silver or gold.

15. The adhesive ornament of claim 13 wherein at least one of said plural separate ornamental objects is iridescent.

16. An applique for placing on a workpiece surface an ornamental pattern of pseudo-rhinestones, comprising:
a foundation sheet;
a transfer sheet;
plural, separate pseudo-rhinestones sandwiched between said foundation sheet and said transfer sheet;
a first adhesive attaching one surface of said plural, separate pseudo-rhinestones to said foundation sheet; and
a second adhesive attaching a second surface of said plural, separate pseudo-rhinestones to said transfer sheet more strongly than said first adhesive attaches said one surface of said plural, separate pseudo-rhinestones to said foundation sheet, but less strongly than said first adhesive attaches, at room temperature, said one surface of said plural, separate pseudo-rhinestones to said workpiece surface.

17. An applique comprising:
plural pseudo-rhinestones arranged in a predetermined pattern;
a foundation sheet supporting said plural pseudo-rhinestones;
a transfer sheet which lifts said plural pseudo-rhinestones from said foundation sheet and places said plural pseudo-rhinestones on human skin while maintaining said plural pseudo-rhinestones arranged in said predetermined pattern.

18. A method of making an ornament for application to a surface, comprising:
positioning a foundation layer in face-to-face relationship with a second sheet, said second sheet comprising:
a pressure-sensitive adhesive layer doped with glitter; and
a clear plastic layer bonded to said adhesive layer,
placing said first and second sheets in a press which has a die attached to one surface, said die having upraised ornament forming elements arranged in a decorative pattern on the surface facing said sheets;
heating said die;
pressing said die into said second sheet, the temperature of the die being sufficient to melt through said second sheet to form upraised ornaments in said patterns without severing said foundation layer;
applying adhesive to a transfer sheet, said adhesive bonding more strongly to said clear plastic layer of said ornament patterns than said adhesive layer bonds to said foundation layer; and
applying said transfer sheet with said adhesive over said pattern of ornaments and said foundation layer.

19. A method for ornamenting human skin, comprising:
positioning a pattern of pseudo-jewels on a foundation;
positioning a transfer sheet over said pattern of pseudo jewels without removing said pattern of pseudo-jewels from said foundation;
peeling said transfer sheet with said pattern of pseudo-jewels from said foundation;
pressing said pattern of pseudo-jewels against human skin without removing said pattern of pseudo-jewels from said transfer sheet; and
peeling said transfer sheet from said human skin without removing said pattern of pseudo-jewels from said skin.
